(19) United States
(12) Patent Application Publication
(10) Pub. No.: US 2013/0025707 A1
(43) Pub. Date: Jan. 31, 2013

(54) FAUCET ATTACHMENT BRACKET

(71) Applicant: LAYTON ADAM MCPHAIL, Autryville, NC (US)

(72) Inventor: LAYTON ADAM MCPHAIL, Autryville, NC (US)

(21) Appl. No.: 13/403,265

(22) Filed: Feb. 23, 2012

Related U.S. Application Data
(60) Provisional application No. 61/513,455, filed on Jul. 29, 2011.

(51) Int. Cl. F16L 3/00

(52) U.S. Cl. 137/360

(57) ABSTRACT

A faucet attachment bracket and system include a metal plate and a collar. The faucet attachment bracket may couple a faucet to a pipe disposed within a wall interior. The collar may include a first end and a second end. The collar may extend orthogonally through the metal plate. The first end may be adapted to receive a faucet stem. The second end may adapted to fit through a hole in a wall and receive a pipe end of the pipe. The collar may align the faucet stem to the pipe end.

### CROSS-REFERENCE TO RELATED APPLICATION

This application claims benefit under 35 U.S.C. §119(e) of U.S. Provisional Application having Ser. No. 61/513,455 filed Jul. 29, 2011, which is hereby incorporated by reference herein in its entirety.

### BACKGROUND OF THE INVENTION

The present invention generally relates to plumbing hardware, and more particularly to, a faucet attachment bracket.

Installation of plumbing may typically involve connecting piping through walls. For example, when installing an exterior faucet, one may need to punch a hole through a stone, brick, or concrete exterior wall when preparing the faucet for connection to a pipe disposed within the wall's interior. The hole punched however, may typically be larger than necessary. The faucet to pipe fitting may be of a different diameter than the interior pipe because one element may be male while the other female. The result can be a gap between the pipe and the surrounding wall. Gaps between the pipe and the wall can allow pests and the elements to enter the wall interior. Additionally, gaps between the faucet and wall may allow excessive movement or rattling of the pipe potentially loosening the faucet. A loosened faucet may become leaky requiring remedial attention.

One approach to a typical exterior faucet installation is to bridge the gap with a filler or foam sealant. However, fillers or foam sealants can degrade over short periods of time allowing gaps to re-develop.

As can be seen, there is a need for an apparatus that can provide a secure attachment of a faucet to a wall.

### SUMMARY OF THE INVENTION

In one aspect of the present invention, a faucet attachment bracket comprises a plate; and a collar including a first end and a second end, wherein the collar extends orthogonally through the plate, the first end is adapted to receive a faucet stem, the second end is adapted to fit through a hole in a wall, the second end further adapted to receive a pipe end of a pipe positioned on an interior of the wall, and the collar is configured to align the faucet stem to the pipe end.

In another aspect of the present invention, a system for mounting plumbing to a pipe within a wall interior of a wall comprises a metal plate including an exterior facing side, and a wall mounting side adapted for attachment to the wall; a collar extending through the metal plate, the collar including a first end projecting beyond the exterior facing side and a second end projecting beyond the wall mounting side, wherein the second end is configured to receive the pipe; and an exterior faucet attached to the first end.

These and other features, aspects and advantages of the present invention will become better understood with reference to the following drawings, description and claims.

### BRIEF DESCRIPTION OF THE DRAWINGS

FIG. 1 is a front plan view of a faucet attachment bracket according to an exemplary embodiment of the invention; and

FIG. 2 is a side view of a faucet attachment system employing the faucet attachment bracket of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a faucet attachment bracket comprising a plate adapted to be fastened to the wall of a building and having a collar through which a faucet can be coupled to a pipe located within a wall. In one aspect, exemplary embodiments of the present invention may align the faucet and pipe. In another aspect, the coupling of the faucet and pipe is fixedly braced to the wall minimizing movement of the pipe within the wall. In the description that follows, the term “exterior” may refer to an element that is exposed to the outdoors.

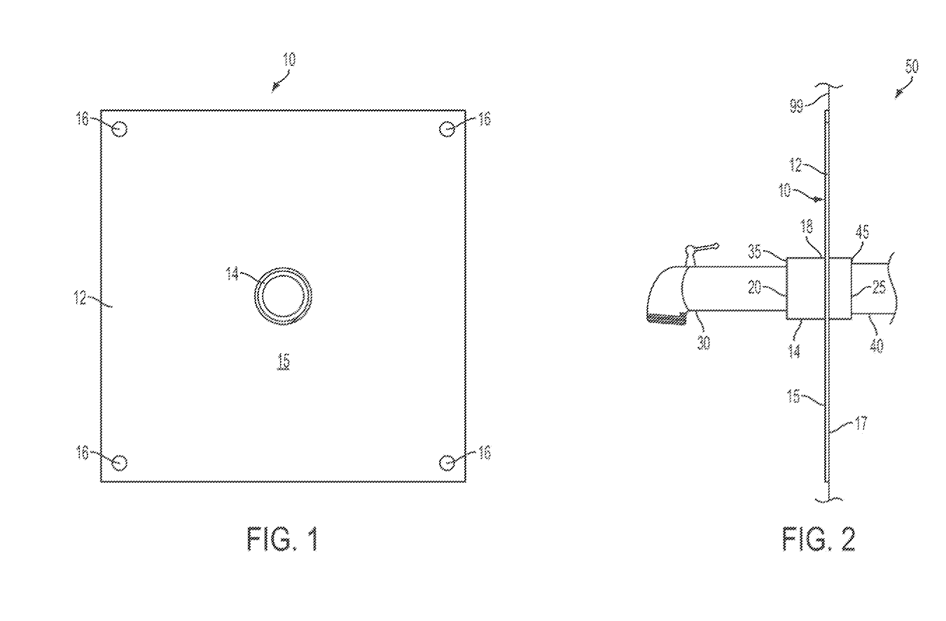

Referring to FIG. 1, an exemplary embodiment of a faucet attachment bracket 10 may include a plate 12 and a collar 14.

Referring to FIGS. 1 and 2, the plate 12 may include an exterior facing side 15 and a wall mounting side 17. In one aspect, the wall mounting side 17 may be planar to a wall 99. The plate 12 can be any shape. In an exemplary embodiment, the plate 12 may be square or rectangular, being about six inches at the widest dimension and about six inches at the narrowest dimension. The plate 12 may be, for example, metal such as steel or hardened plastic. When made from metal, the plate 12 may be a rust resistant metal or may be coated with a rust resistant material. The plate 12 may include fastener openings 16 near its perimeter. The openings 16 may be positioned for example, near the corners of a square or rectangular plate 12 (FIG. 1) and can serve as anchor points for fastening devices such as screws or bolts which can be inserted through the openings 16 to fasten the plate 12 to the wall 99.

The collar 14 may be attached to the plate 12. In an exemplary embodiment, the collar 14 may be welded to the plate 12 by means of weld joints 18. In one exemplary embodiment, the collar 14 may extend through the plate 12. An exterior end 20 of the collar 14 may be disposed on the exterior facing side 15 of the plate 12. An interior end 25 of the collar 14 may be disposed on the wall mounting side 17 of the plate 12. In one exemplary embodiment, the collar 14 may extend orthogonally through the plate 12 so that the exterior end 20 may extend beyond the exterior facing side 15 and the interior end 25 may extend beyond the wall mounting side 17.

In one aspect, the collar 14 may be configured to detain a pipe end 45 of a pipe 40 and a faucet stem 35 of a faucet within the collar 14 with minimal movement. The pipe 40 may be disposed within an interior of the wall 99. The interior end 25 may be configured to receive the pipe end 45. In an exemplary embodiment, the interior end 25 may be threaded. In another aspect, the collar 14 may also be adapted to receive the faucet 30. The faucet 30 may be for example, a hose bib. The exterior end 20 may be adapted to receive the faucet stem 35. In an exemplary embodiment, the exterior end 20 may be threaded. In one aspect, the collar 14 may be configured to align the faucet stem 35 to the pipe end 45.

Referring to FIG. 2, a system 50 may include the faucet attachment bracket 10 and the faucet 30 coupled to the collar 14.

During an exemplary use and installation of the faucet attachment bracket 10 to the wall 99, a hole (not shown) may be drilled into the wall 99 to provide a press fit of the collar 14 through the hole. The plate 12 may be positioned flush against the exterior of the wall 99 with the interior end 25 of the collar 14 inserted through the hole. The interior end 25 may be aligned with the pipe end 45 and rotated about or press fit onto the pipe end 45 until a secure connection is made. It will be understood that using sealants or tape around the connection of the pipe end 45 to the interior end 25 may be employed as known in the art. The plate 12 may be fixedly anchored to the wall 99. In exemplary embodiments where the faucet 30 is separate from the faucet attachment bracket 10, the faucet 30 may be inserted into the exterior end 20 until secure. In exemplary embodiments where the faucet 30 may be already attached to the collar 14, for example, in exemplary embodiments of systems 50, the plate 12 may be affixed to the wall 99 when the faucet 30 is aligned correctly to the pipe end 45. When installation of the faucet attachment bracket 10 or the system 50 onto the wall 99 is finished, the collar 14 may be disposed to maintain the pipe end 45 and faucet stem 35 from moving into the hole (not shown) of the wall 99. Additionally, the interior of the wall 99 may be shielded from exposure to the elements on the exterior of the wall 99 by the plate 12.

It should be understood, of course, that the foregoing relates to exemplary embodiments of the invention and that modifications may be made without departing from the spirit and scope of the invention as set forth in the following claims.

What is claimed is:

1. A faucet attachment bracket, comprising:
a plate; and
a collar including a first end and a second end, wherein
the collar extends orthogonally through the plate,
the first end is adapted to receive a faucet stem,
the second end is adapted to fit through a hole in a wall,
the second end further adapted to receive a pipe end of a pipe positioned on an interior of the wall, and
the collar is configured to align the faucet stem to the pipe end.

2. The faucet attachment bracket of claim 1, wherein the first end is a threaded end.

3. The faucet attachment bracket of claim 2, wherein the second end is a threaded end.

4. The faucet attachment bracket of claim 3 wherein the first end and second end extend outward from the plate.

5. The faucet attachment bracket of claim 4 wherein the plate is adapted to be fixedly mounted to the wall.

6. A system for mounting plumbing to a pipe within a wall interior of a wall, comprising:
a metal plate including an exterior facing side, and a wall mounting side adapted for attachment to the wall;
a collar extending through the metal plate, the collar including a first end projecting beyond the exterior facing side and a second end projecting beyond the wall mounting side, wherein the second end is configured to receive the pipe; and
an exterior faucet attached to the first end.

7. The system of claim 6, wherein the first and second ends are threaded.

8. The system of claim 6, wherein the wall mounting side of the metal plate is planar to the wall.
